(19) United States
(12) Patent Application Publication
(10) Pub. No.: US 2025/0111688 A1
(43) Pub. Date: Apr. 3, 2025

(54) DIGITAL STAMP LOCALIZATION AND OVERLAPPING TEXT REMOVAL METHOD AND APPARATUS

(71) Applicant: KONICA MINOLTA BUSINESS SOLUTIONS U.S.A., INC., Foster City, CA (US)

(72) Inventor: Junchao Wei, San Mateo, CA (US)

(21) Appl. No.: 18/478,979

(22) Filed: Sep. 29, 2023

(51) Int. Cl. G06V 30/148; G06V 30/18

(52) U.S. Cl. CPC G06V 30/155; G06V 30/18105

(57) ABSTRACT

In a form recognition system, a deep learning system may be trained to perform stamp localization for stamp removal to facilitate form recognition. In embodiments, a stamp mask identifies locations of stamps or seals on forms, and a line mask identifies pixels of the stamps. Where a stamp or seal overlaps with underlying text on a form, and a color or grayscale of the stamp or seal is sufficiently similar to that of the underlying text, a combination of the stamp mask and the line mask may enable removal of the stamp or seal without degrading the underlying text in the form, and facilitate form recognition.

### FIELD OF THE INVENTION

Aspects of the present invention relate to document and form analysis, more particularly location and removal of ink stamps or seals in images, and still more particularly in images such as invoices, receipts, or official documents. Herein, reference to one of stamps or seals will refer to either or both of these. Reference to one of invoices, receipts, or official documents will refer to any one or more of these.

### BACKGROUND OF THE INVENTION

In the field of document and form analysis, robotic process automation (RPA) document processing is being used increasingly, involving both feature localization and form matching. Document and form analysis can present additional challenges when extracting correction information from a large number of forms in order to train a document processing system. Such challenges can include image scanning noise, quality and color degradation, image warping, and rotation.

A recent issue to be addressed is the inclusion of stamps on forms. In the course of using documents to train document processing systems, some training documents may contain such stamps. These stamps can appear in different places around documents such as invoices or receipts. Frequently, a stamp may appear in a document header or footer region, or near the top or bottom of a document, for example, near lines identifying a billing source company and/or address. However, some stamps can appear in a number of different places on documents.

It would be desirable to devise an algorithm that accounts for stamp or seal color, density, and/or shape to accomplish stamp localization and segmentation.

### SUMMARY OF THE INVENTION

Aspects of the present invention provide a deep learning based model to predict both stamp location and segment stamp pixels in both color and grayscale forms. In an embodiment, segmentation may be accomplished using a line mask.

Aspects of the present invention take advantage of both color filter methods and generalized grayscale models, thereby increasing accuracy and efficiency of processing both color forms and grayscale forms. When a stamp or seal is grayscale, and the underlying form text also is grayscale, the stamp or seal may be virtually indistinguishable from the text. More generally, when a stamp or seal is the same color as the underlying text, the stamp or seal may be virtually indistinguishable from the text. Stamp location prediction helps to enable grayscale stamp or seal removal.

In an embodiment, a stamp localization model provides two main channel outputs. A first channel may output a stamp or seal pixel segmentation map (a stamp mask). A second channel may output a mask comprising regions to estimate locations of foreground text lines and mask only stamp text (a line mask). The stamp mask enables localization and detection of stamps on a form. The line mask enables further segmentation of foreground text lines while preserving original pixels on the text lines. In this fashion, it is possible to balance use of stamp pixel estimation and text line detection, improving performance of the stamp localization and the line segmentation.

### BRIEF DESCRIPTION OF THE DRAWINGS

Various aspects of the invention now will be described in detail with reference to exemplary non-limiting embodiments, with reference to the accompanying drawings, in which:

FIGS. 1 to 10 are images of various types of forms bearing various stamps or seals;

FIG. 11 is a flow chart depicting aspects of operation according to an embodiment;

FIG. 12 is a diagram of a semantic network according to an embodiment;

FIG. 13 is a high level block diagram according to an embodiment;

FIG. 14 is a high level block diagram of portions of FIG. 12 according to an embodiment;

FIG. 15 is a high level block diagram of portions of FIG. 13 according to an embodiment;

FIG. 16 is a high level chart showing sequence of processing of invoices according to an embodiment;

FIG. 17 shows images of an original document, a processing result according to an embodiment, and a further processing result according to an embodiment.

### DETAILED DESCRIPTION OF EMBODIMENTS

Aspects of the present invention address challenges that stamps or seals on documents can present to a document processing system, including the training of such a system. Such stamps or seals can serve various purposes. For example, on Japanese invoices or other documents, a seal, or hanko, may be used as a form of acknowledgement or agreement. In other types of invoices, a “paid” or “received” stamp may be used so that the reader can understand the invoice status—for example, “received” would not mean “paid”. “Paid,” however, would imply that the invoice had been received.

The ink in the stamps or seals can have various colors (for example, red or blue, or both), or may be relatively monotone (for example, black or grayscale). The stamps may contain foreground text. For different companies, stamp designs and content may vary. Such variations can be helpful for purposes of form identification and matching.

In addition, a stamp can cover foreground text and can overlap important target text information and useful location information for accurate form registration. As a result of such coverage and/or overlap, a document processing system may identify a form incorrectly, and/or may incorrectly identify information such as keyword location and content, to match the form with others. Consequently, overall system accuracy and quality may be diminished.

Stamps can have different shapes, such as squares and rectangles, other polygonal shapes, or circles. Some of these shapes may appear on an invoice or receipt with text at an angle relative to the underlying document, as if the shapes had been rotated at some kind of angle, with slight rotations.

Grayscale forms or documents with grayscale stamps can be more difficult to process than the ones just described, in that the grayscale stamps may differ only in density from the foreground text. Still further, grayscale forms may contain pixel density information, making text and feature segmentation difficult. Also, when the stamp text and the foreground text overlap, both can be difficult to read. Sometimes, foreground text can include the same color as the stamp text, for example, red.

In some instances, a logo having a particular shape, such as a square or circle, could be recognized as a stamp. Handling such logos can complicate development and performance of algorithms to remove the stamps or seals. Another shape which is appearing more frequently on forms is a QR code. Usually QR codes do not interfere with other text on a form, but in instances in which a stamp comes

There are times when it is desirable to remove stamps digitally from an invoice or receipt, in order to be able to read what is beneath the stamp.

In the following description, aspects of the present invention address various ones of the just-identified challenges by providing a deep learning based model to predict both stamp location and the appropriate mask for segmenting the stamp pixels. In the discussion herein, the terms “form,” “document,” and “digital document” may be used interchangeably.

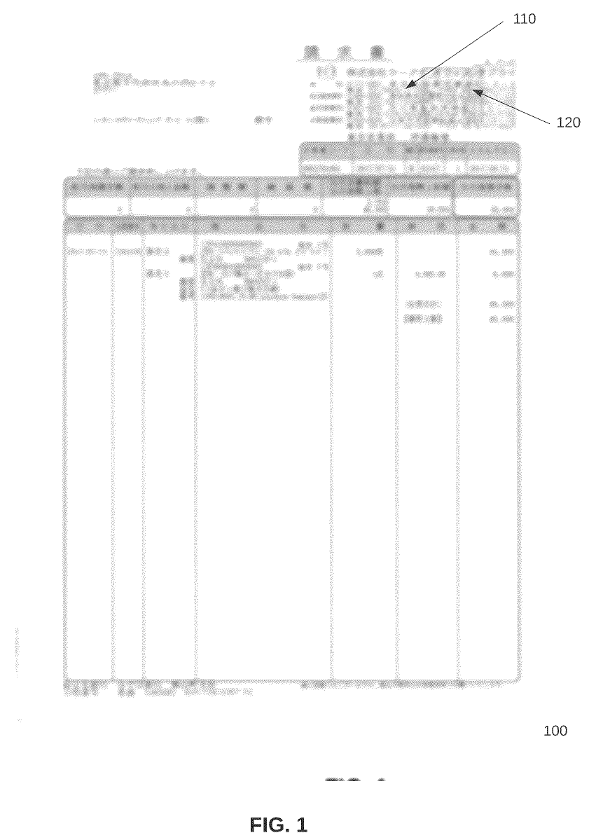

FIGS. 1-10 depict different examples in which a stamp or seal may appear on a document such as an invoice or a receipt. In several of these examples, the stamp or seal covers or overlaps text of the underlying document. In several more of these examples, the stamp or seal appears separately from the text of the underlying document. In some of these examples, the stamp or seal appears tilted or at an angle with respect to the text of the underlying document. In various ones of these examples, the document may have different colors, and the stamp or seal may have different colors, in some cases, different from the color or colors of the document on which the stamp or seal appears.

In FIG. 1, invoice 100 is in grayscale. Text 110 at an upper right hand corner of invoice 100 is black. Red square stamp 120, which contains some text and a pattern, overlies part of text 110.

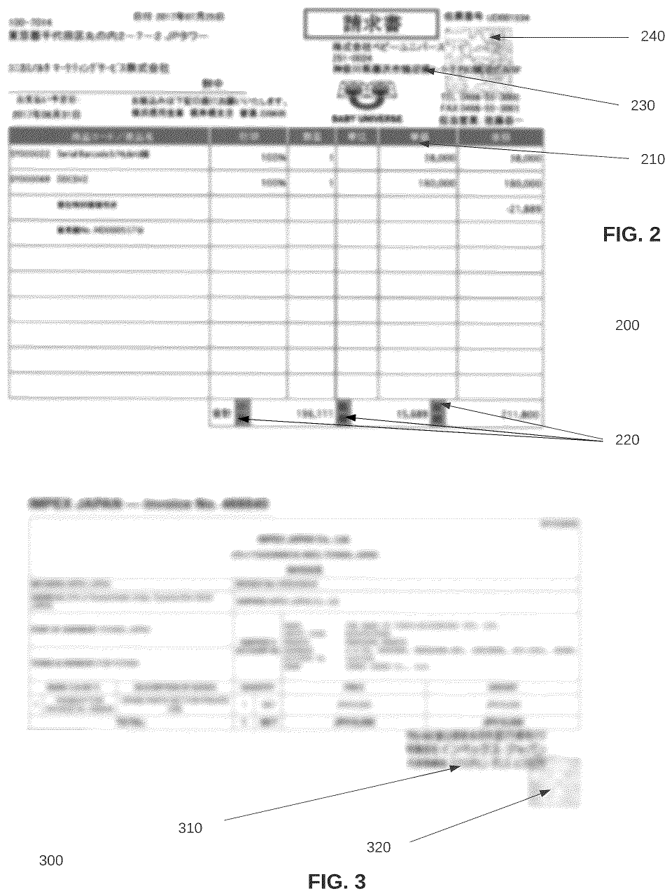

In FIG. 2, invoice 200 is in multiple colors, including purple portions 210, blue portions 220, and grayscale/black portions 230. Red square stamp 240 overlies some of the text in the invoice.

In FIG. 3, invoice 300 is black and white, including black text 310. Red square stamp 320, which contains some text and a pattern, overlies part of text 310.

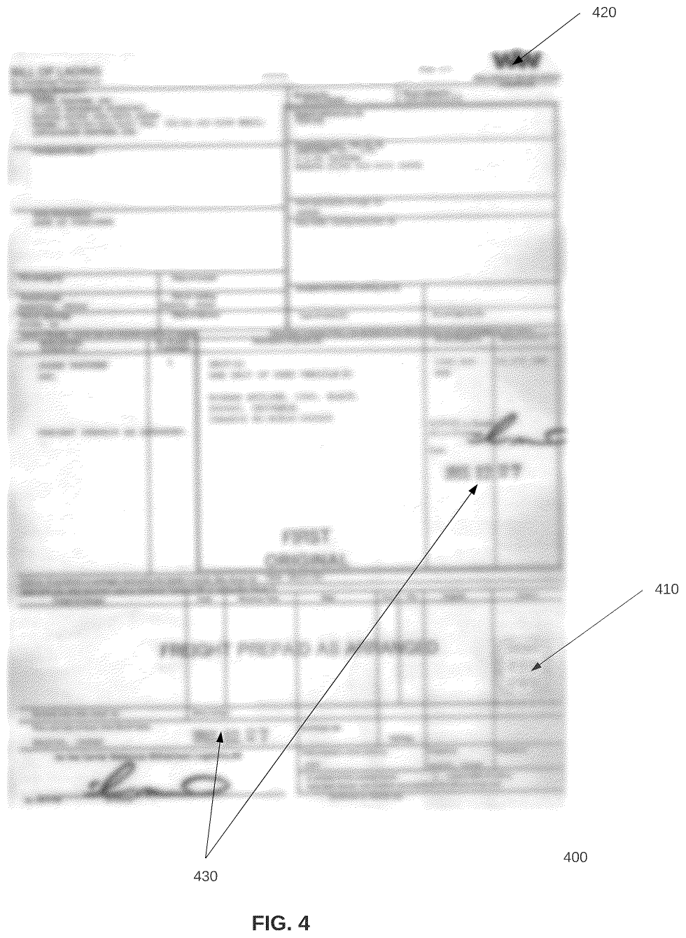

In FIG. 4, bill of lading 400 is largely black and white, but contains red rectangular stamp 410 with a number and accompanying text; blue logo 420; and blue stamped date 430.

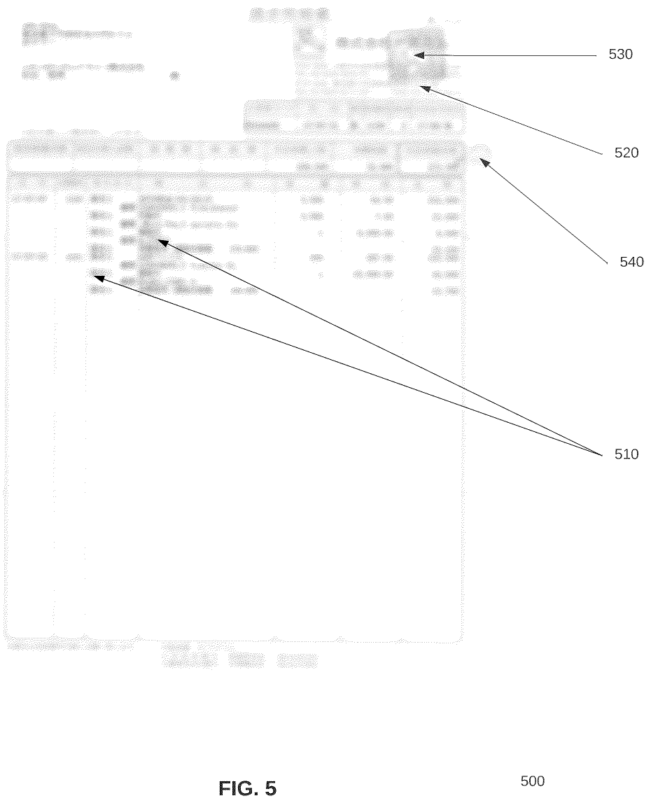

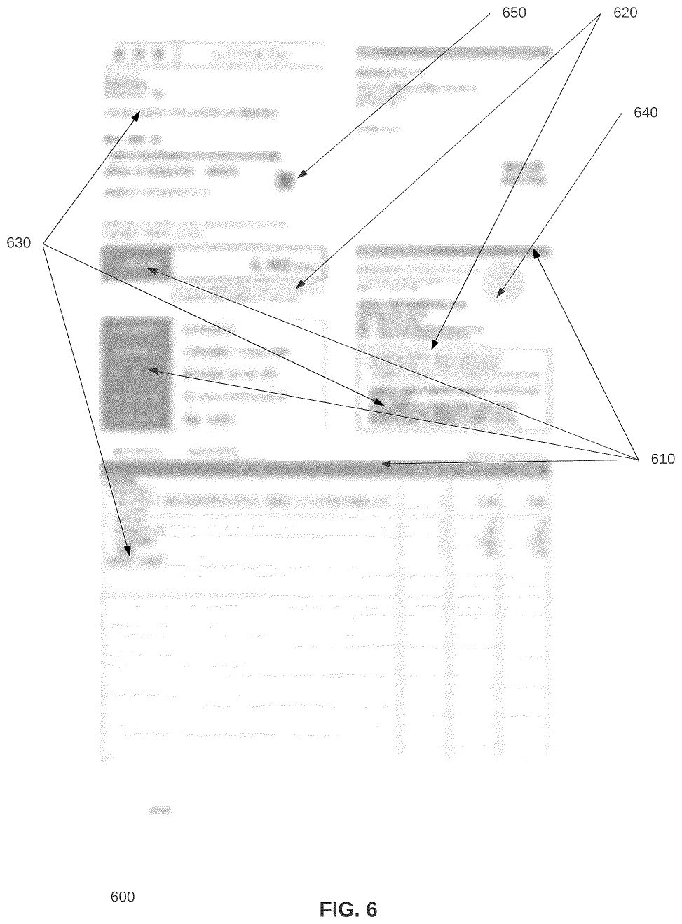

In FIG. 5, order form 500 contains black text 510, with magenta text 520 and magenta square stamp 530 overlying some of the magenta text 520. An additional red circular stamp 540 lies just outside of fields of the order document 500.

In FIG. 6, order form 600 contains a number of blue portions 610 as part of the format of the document. There also is magenta text 620, and black text 630. A red circular stamp 640 appears on the document, not covering any text. A QR code 650 also appears on the document. The QR code 650 has a square shape, and at first glance can look similar to a stamp. In an embodiment, QR codes are differentiated from stamps.

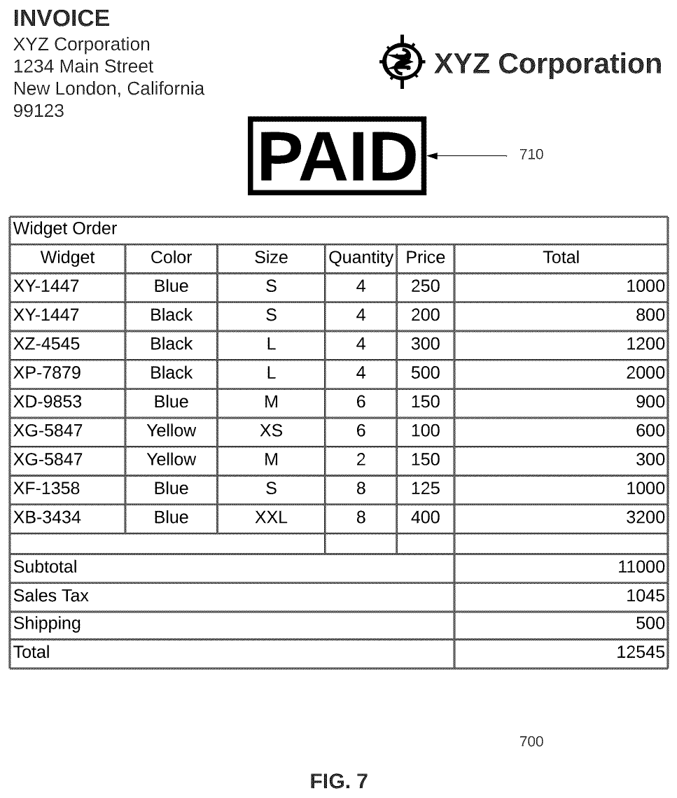

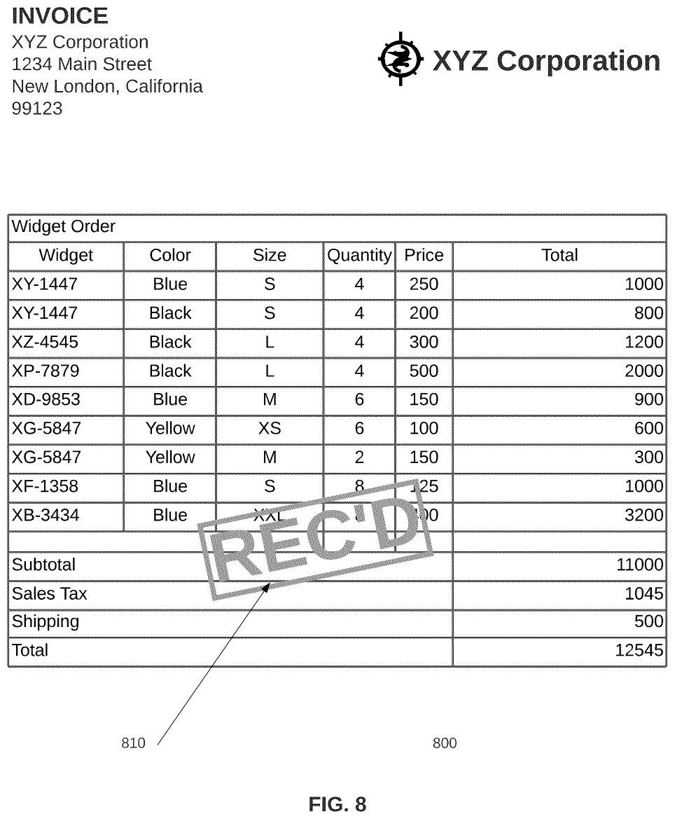

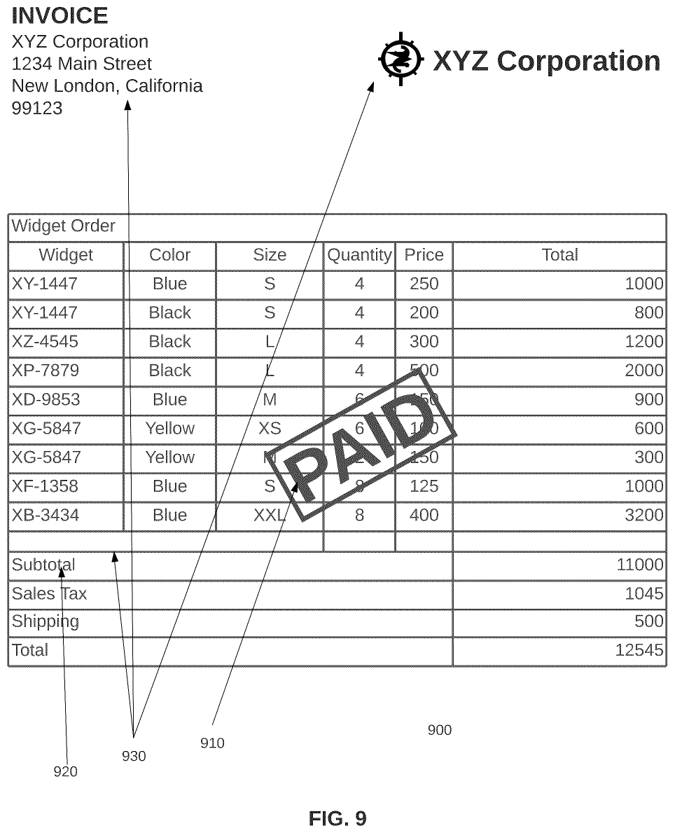

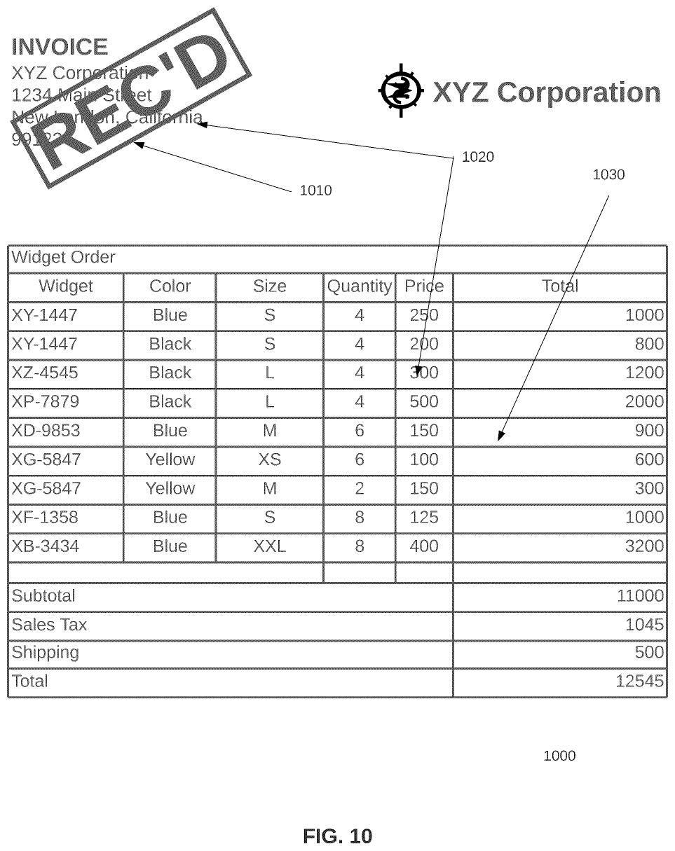

Stamps or seals to be differentiated from text do not appear only in Japanese language documents. In FIG. 7, an invoice 700 is in black text. A black PAID stamp 710 is on the invoice 700, but does not overlap any text. FIG. 8 shows invoice 800 with the same text as invoice 700, but with a grayscale REC′D stamp overlying some of the text. FIG. 9 shows invoice 900 with the same text as invoices 700 and 800, with red stamp 920 overlying some of the text 920, which also is red. The borders and header portions of the invoice 900 are black, as denoted by 930. Header portion of invoice 900 contains a logo which must be distinguished from stamp 910. FIG. 10 shows invoice 1000, again with the same text as invoices 700, 800, and 900, but with magenta text 1010 and blue REC′D stamp 1020 overlying some of the magenta text. The invoice 1000 also contains black borders 1000.

FIGS. 1-10 provide a non-exhaustive list of combinations of forms, form colors, and stamp or seal colors for which differentiation is required for document processing. The stamps or seals in these Figures appear in various places on the different forms. Among the challenges in processing such forms are the recognition of form type and identification of stamp appearance and location on different forms.

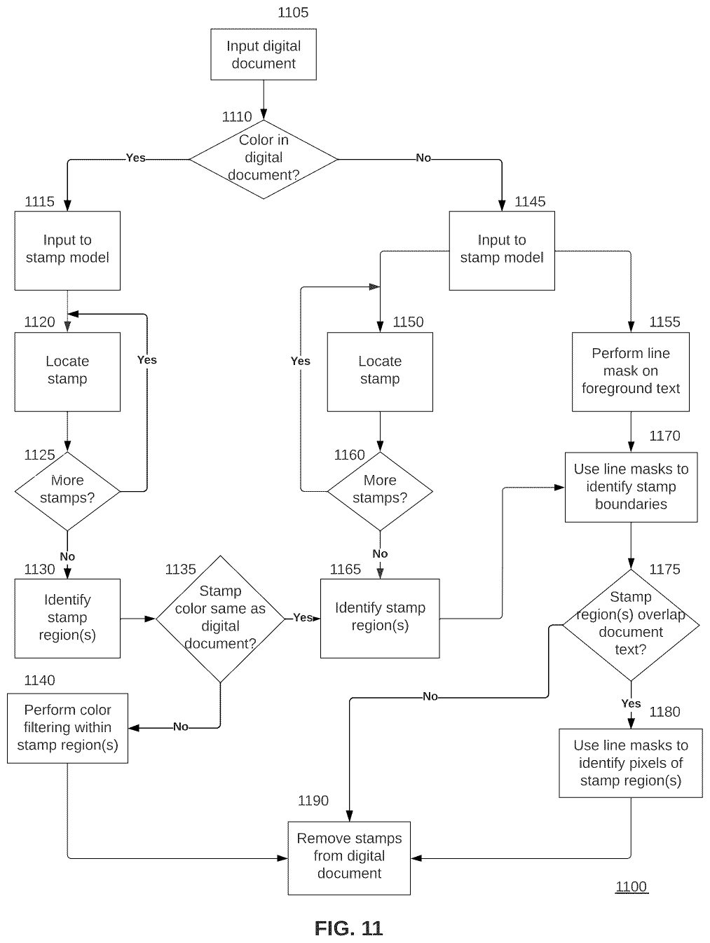

FIG. 11 shows a flow chart to describe operation of aspects of the present invention according to an embodiment. At 1105, a digital document is input. Depending on the embodiment, the digital document may be an invoice, a bill of lading, an order form, or other type of document which may have a stamp or seal placed on it. The digital document may be input in various ways which are not critical to the implementation of embodiments. The digital document may be the result of a scan, or may be retrieved from storage. At 1110, a determination is made whether the digital document contains any color. Color may appear anywhere in the digital document, including as part of the text, or as part of one or more tables in the digital document, or as stamps on the digital document. In an embodiment, this determination may be the result of RGB or CYMK pixel analysis.

Responsive to a determination that the digital document contains color, then at 1115 the digital document is input to a stamp model, and at 1120, a stamp is located. The process cycles between 1125 and 1120 until all stamps are located. Once they all are located, at 1130 a stamp region is identified for each of the stamps located previously. Ordinarily skilled artisans will appreciate that when a stamp is the same color as the underlying text, even if the color is not black, white, or some type of grayscale, treatment of the stamp in a grayscale fashion is necessary.

At 1110, responsive to a determination that the digital document does not contain color, i.e. that the digital document is black and white or grayscale, then at 1145 the image is input to a stamp model, and at 1150, a stamp is located. The process cycles between 1150 and 1160 until all stamps are located. Once they all are located, then at 1165 a stamp region is identified for each of the stamps located previously.

At 1135, responsive to a determination that one or more of the localized stamps has the same color as underlying text in the form, flow may progress to 1165, to identify what effectively would be the equivalent of a grayscale region where the localized stamps have the same color as the underlying text. Responsive to a determination that the colors are different, at 1140 color filtering may be performed within the stamp regions, so that at 1190, the color stamp(s) may be removed from the digital document.

As a second channel, after the image is input to the stamp model at 1145, at 1155 line masking is performed on foreground text of the digital document. At 1170, the generated line masks may be used to identify boundaries of stamps or seals in the digital document. These boundaries may be identified in response to identification of grayscale or corresponding stamp regions at 1165.

At 1175, a determination is made whether any of the stamp regions overlap text any text in the underlying digital document. Responsive to a determination that there is overlap, at 1180 the generated line masks may be used to identify pixels of the overlapping stamp regions. Then, at 1190, the stamp(s) may be removed from the digital document. Responsive to a determination that there is no overlap, that is, that the stamp(s) occur in the digital document separately from the other text in the digital document (as is the case, for example, for one or more of the stamps in FIGS. 5, 6, and 7), at 1190 the stamps may be removed from the digital document in one of a number of known techniques, including either color filtering or line masking as discussed earlier, or by other masking and/or pixel removal techniques.

After stamp removal at 1190, in an embodiment the digital document that remains may be a form that may be used in form recognition or processing, or in training of the deep learning model that is used for stamp localization and overlapping text removal.

It should be noted that while the flow chart of FIG. 11 shows an exemplary sequence of operation, the invention is not limited to the specific sequence shown. Various elements in FIG. 11 may be performed in parallel, or in otherwise different sequences from the one that the embodiment of FIG. 11 depicts. In addition, a deep learning system according to embodiments may be able to determine that, for some digital documents, the appropriate mixture of stamp masking and line masking may be performed. For some digital documents, line masking may not be necessary, and so may be omitted. In such circumstances, only stamp masking may be necessary. For other digital documents, stamp masking may not be possible, and so may be omitted. In such circumstances, only line masking may be performed.

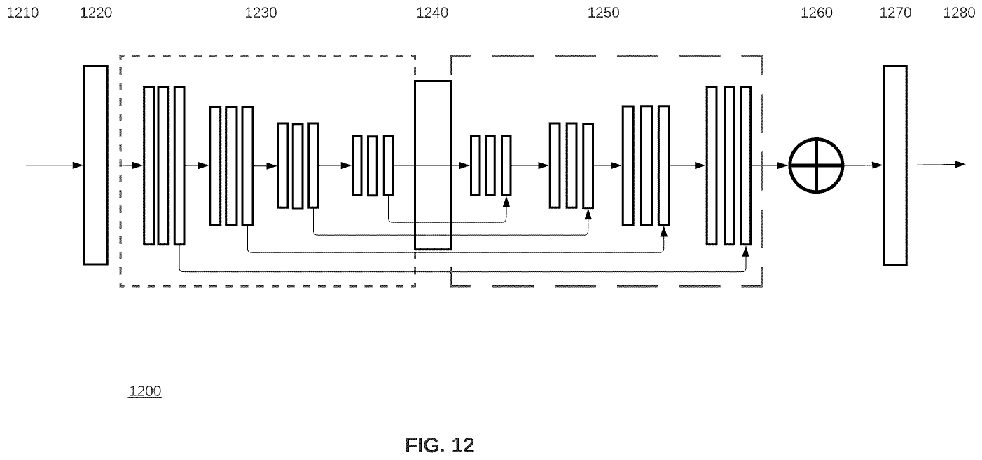

FIG. 12 is a high level diagram of a semantic network according to an embodiment. In FIG. 12, input image 1210 passes into input network 1220, which in an embodiment may be a tensor network. Encoder network 1230, which in an embodiment may be a convolutional neural network (CNN), in particular a Resnet network, receives the input from the input network 1220. Self-attention mechanism 1240 may receive an output of encoder network 1230, and may provide inputs to decoder network 1250. Summer 1260 may sum outputs of decoder network 1250 according to desired weighting of the outputs, and may provide an output to output network 1270, which also may be a tensor network depending on the embodiment, to yield output 1280.

In an embodiment, a self-attention mechanism based on CNN features may adjust learned weights in encoder network 1230 to provide greater weighting to more important features. In an embodiment, correlations among individual pixels may be calculated to enable the weight adjustment. In an embodiment, the self-attention mechanism may include an attention gate module, which can aggregate information from encoder network 1230 and upsampled information while adjusting the weights. In an embodiment, the network may utilize a set of implicit reverse attention modules and explicit edge attention guidance to establish a relationship between regions where stamps may be localized, and boundaries of the localized stamps.

In an embodiment, self-attention mechanism 1240 can obtain long-range feature information and adjust the weights of feature points by aggregating correlation information of global feature points. Although embodiments of self-attention mechanisms can improve the deep learning model's recognition accuracy, issues of excessive time, slow training speed, and/or excessively numerous weighting parameters may arise. One approach to reducing the amount of time is through use of tensor decomposition, in which higher rank tensors may be decomposed into linear combinations of lower-rank tensors. Thus, for example, input tensor network 1220 may have a rank of three, but output tensor network 1270 may have a rank of two.

Resnet networks can provide a large number of convolutional layers, in some cases, as many as thousands. Common numbers of layers in such networks are 18, 34, 50, 101, and 152. In an embodiment, as few as 18 convolutional layers may be satisfactory.

From the model output, there can be two main channel outputs. The first channel outputs the stamp or seal pixel segmentation map. The second channel outputs a mask of regions which estimates the locations of foreground text lines and masks only stamp texts. Using the stamp mask (1st channel), it is possible to localize and detect the stamps in the form. Then, using the line mask (2nd channel), it is possible to segment further the foreground text lines while preserving the original pixels on the text lines without damaging them. This solution balances stamp pixel estimation and text line detection, which can achieve high performance stamp localization and line segmentation.

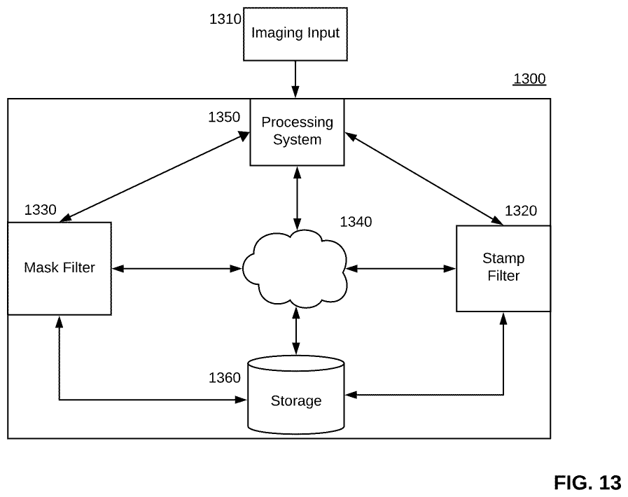

FIG. 13 is a high level block diagram of a computing system 1300 which may implement one or more deep learning systems 1200 to perform stamp localization and text removal according to embodiments. Depending on the embodiment, imaging input 1310 may have a library of images which can include training images as well as images which are to be processed. In an embodiment, imaging input 1310 may include scanners, cameras, or other imaging equipment for scanning an invoice or other document as an input, and may provide training data for the one or more deep learning systems 1200. Processing system 1350 may be a separate system, or it may be part of imaging input 1310, depending on the embodiment. Processing system 1350 may include one or more processors, one or more storage devices, and one or more solid-state memory systems (which are different from the storage devices, and which may include both non-transitory and transitory memory).

In an embodiment, processing system 1350 may include a deep learning system 1200 which stamp filter 1320 and mask filter 1330 use to perform stamp localization and text removal, depending on the embodiment. In other embodiments, either stamp filter 1320 or mask filter 1330 may implement its own deep learning system 1200, or each of stamp filter 1320 and mask filter 1330 may implement its own deep learning system 1200. In embodiments, each of stamp filter 1320 and mask filter 1330 may include one or more processors, one or more storage devices, and one or more solid-state memory systems (which are different from the storage devices, and which may include both non-transitory and transitory memory). In embodiments, additional storage 1360 may be accessible to one or more of stamp filter 1320, mask filter 1330, and processing system 1350 over a network 1340, which may be a wired or a wireless network or, in an embodiment, the cloud.

In an embodiment, storage 1360 may contain training data for the one or more deep learning systems 1200, and/or may contain stamp localization and/or mask filtering results. Storage 1340 may store input images from imaging input 1310, and/or may store images to be processed, and/or may store processed images with stamps or seals removed.

Where network 1340 is a cloud system for communication, one or more portions of computing system 1300 may be remote from other portions. In an embodiment, even where the various elements are co-located, network 1340 may be a cloud-based system.

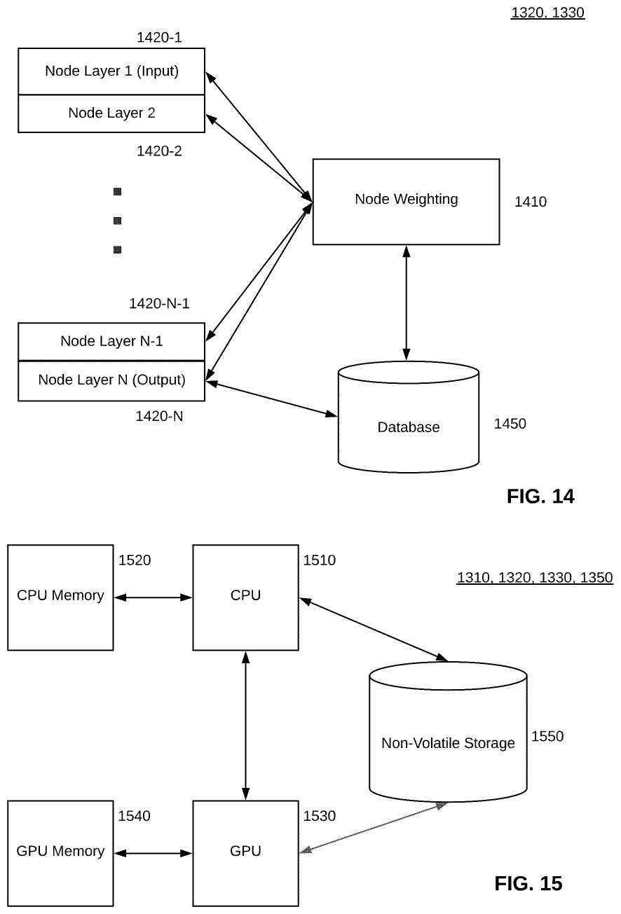

FIG. 14 is a high level diagram of apparatus for weighting of nodes in a deep learning system according to an embodiment. As training of a deep learning system proceeds according to an embodiment, the various node layers 1420-1, . . . , 1420-N may communicate with node weighting module 1410, which calculates weights for the various nodes, and with database 1450, which stores weights and data. As node weighting module 1410 calculates updated weights, these may be stored in database 1450.

FIG. 15 is a high level diagram of apparatus to operate a deep learning system according to an embodiment. In FIG. 15, one or more CPUs 1510 communicate with CPU memory 1520 and non-volatile storage 1550. One or more GPUs 1530 communicate with GPU memory 1540 and non-volatile storage 1550. Generally speaking, a CPU may be understood to have a certain number of cores, each with a certain capability and capacity. A GPU may be understood to have a larger number of cores, in many cases a substantially larger number of cores than a CPU. In an embodiment, each of the GPU cores may have a lower capability and capacity than that of the CPU cores, but may perform specialized functions in the deep learning system, enabling the system to operate more quickly than if CPU cores were being used.

Depending on the embodiment, one or more of the stamp filter 1320, mask filter 1330, processing system 1350, and node weighting module 1410 may employ the apparatus shown in FIG. 15.

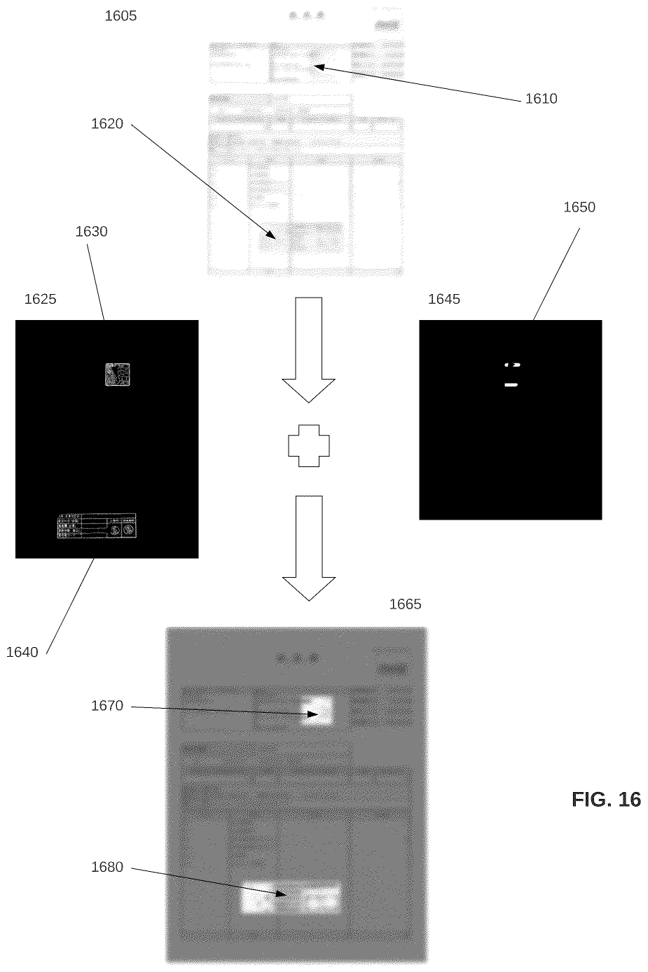

FIG. 16 an example of grayscale output according to an embodiment. Form 1605 with stamps 1610 and 1620 are input. In respective channels as shown in FIG. 11, an output 1625 with localized stamps 1630 and 1640, and an output 1645 with mask 1650, are combined to provide output 1665, with stamp locations 1670 and 1680 identified.

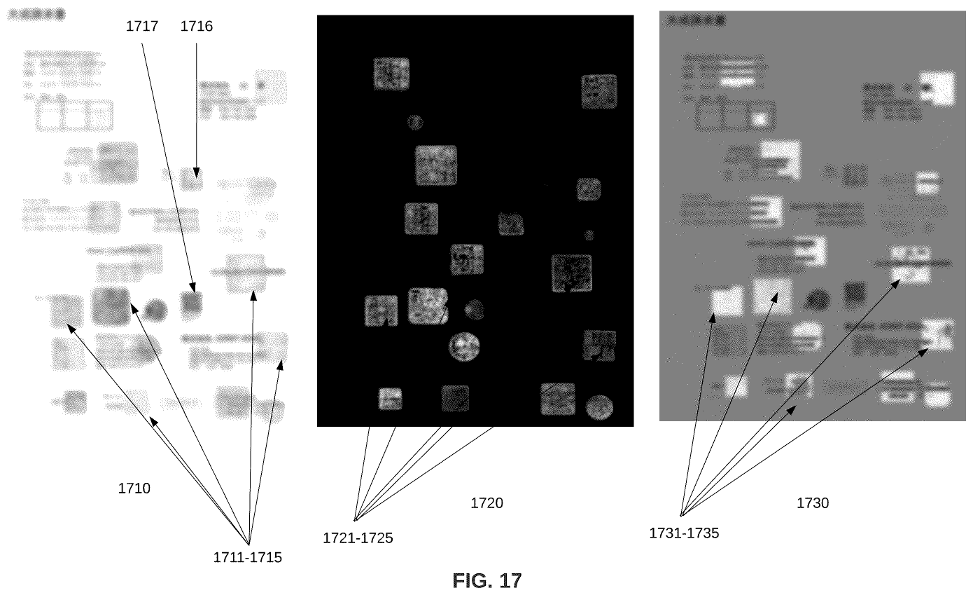

FIG. 17 shows output from the left hand side and the first channel in FIG. 11. Input form 1710 has a number of color and grayscale stamps, including stamps 1711-1715. 1720 is output from the first channel in FIG. 11, with localized stamps including localized stamps 1721-1725. Final output 1730 has locations of all of the identified stamps, including at locations 1731-1735. It should be noted that, as FIG. 17 depicts, not all of the stamps in input 1710 are identified in either 1720 or 1730.

While embodiments of the invention have been described in detail above, ordinarily skilled artisans will appreciate that various modifications within the scope and spirit of the invention are possible. In particular, the identification of certain variants in the course of this description is by no means intended to be an exhaustive list. Rather, identification of those variants provides examples to inform ordinarily skilled artisans about the types of variants that are contemplated here. Accordingly, the scope of the invention is to be construed as limited only by the scope of the following claims.

What is claimed is:

1. A method comprising:
a) responsive to input of a digital document, determining whether there is any color in the digital document;
b) using a deep learning system, responsive to a determination that there is color in the digital document, locating one or more first stamps on the digital document, and identifying a region for each of the one or more first stamps;
c) using the deep learning system, responsive to a determination that the digital document does not contain color, locating one or more second stamps on the digital document, and identifying a region for each of the one or more second stamps;
d) using the deep learning system, responsive to a determination that one of the one or more first and second stamps overlaps underlying text in the digital document, determining whether a color of the one of the one or more first and second stamps is sufficiently similar to a color of the underlying text in the digital document; and
e) using the deep learning system, responsive to a determination that the color of the one of the one or more first and second stamps is sufficiently similar to the color of the underlying text in the digital document, performing line masking to identify pixels of the one of the one or more first and second stamps in the digital document for removal.

2. The method of claim 1, further comprising:
repeating d) and e) for all of the one or more first and second stamps.

3. The method of claim 1, further comprising:
f) using the deep learning system, responsive to c), performing the line masking to identify pixels of the one of the one or more second stamps in the digital document for removal; and
g) repeating f) for all of the one or more second stamps.

4. The method of claim 1, further comprising:
h) using the deep learning system, responsive to a determination that a color of the each of the one or more first stamps is different from a color of the underlying text in the digital document, performing color filtering within the region of the one of the the one or more first stamps; and
i) repeating h) for all of the one or more first stamps.

5. The method of claim 1, further comprising:
j) using the deep learning system, responsive to identification of pixels of the one of the one or more second stamps in the digital document, digitally removing the one of the one or more second stamps from the digital document; and
k) repeating j) for all of the one or more second stamps.

6. The method of claim 1, further comprising:
l) using the deep learning system, responsive to a determination that the one of the one or more first and second stamps does not overlap the underlying text in the digital document, digitally removing the one of the one or more first and second stamps from the digital document; and
m) repeating l) for all of the one or more first and second stamps.

7. The method of claim 4, further comprising:
n) using the deep learning system, responsive to h), digitally removing the one of the one or more first stamps from the digital document; and
o) repeating n) for all of the first stamps.

8. The method of claim 1, wherein the one or more first stamps are color stamps.

9. The method of claim 1, wherein the one or more second stamps are grayscale stamps.

10. The method of claim 1, wherein the deep learning system comprises a system selected from the group consisting of convolutional neural networks (CNN) and Resnet networks.

11. An apparatus comprising:
at least one processor and a non-transitory memory that contains instructions that, when executed, enable the machine learning system to perform a method comprising:
a) responsive to input of a digital document, determining whether there is any color in the digital document;
b) using a deep learning system, responsive to a determination that there is color in the digital document, locating one or more first stamps on the digital document, and identifying a region for each of the one or more first stamps;
c) using the deep learning system, responsive to a determination that the digital document does not contain color, locating one or more second stamps on the digital document, and identifying a region for each of the one or more second stamps;
d) using the deep learning system, responsive to a determination that one of the one or more first and second stamps overlaps underlying text in the digital document, determining whether a color of the one of the one or more first and second stamps is sufficiently similar to a color of the underlying text in the digital document; and
e) using the deep learning system, responsive to a determination that the color of the one of the one or more first and second stamps is sufficiently similar to the color of the underlying text in the digital document, performing line masking to identify pixels of the one of the one or more first and second stamps in the digital document for removal.

12. The apparatus of claim 11, wherein the method further comprises:
repeating d) and e) for all of the one or more first and second stamps.

13. The apparatus of claim 11, wherein the method further comprises:
f) using the deep learning system, responsive to c), performing the line masking to identify pixels of the one of the one or more second stamps in the digital document for removal; and
g) repeating f) for all of the one or more second stamps.

14. The apparatus of claim 11, wherein the method further comprises:
h) using the deep learning system, responsive to a determination that a color of the each of the one or more first stamps is different from a color of the underlying text in the digital document, performing color filtering within the region of the one of the the one or more first stamps; and
i) repeating h) for all of the one or more first stamps.

15. The apparatus of claim 11, wherein the method further comprises:
j) using the deep learning system, responsive to identification of pixels of the one of the one or more second stamps in the digital document, digitally removing the one of the one or more second stamps from the digital document; and
k) repeating j) for all of the one or more second stamps.

16. The apparatus of claim 11, wherein the method further comprises:
l) using the deep learning system, responsive to a determination that the one of the one or more first and second stamps does not overlap the underlying text in the digital document, digitally removing the one of the one or more first and second stamps from the digital document; and
m) repeating l) for all of the one or more first and second stamps.

17. The apparatus of claim 14, wherein the method further comprises:
n) using the deep learning system, responsive to h), digitally removing the one of the one or more first stamps from the digital document; and
o) repeating n) for all of the first stamps.

18. The apparatus of claim 11, wherein the one or more stamps are color stamps.

19. The apparatus of claim 11, wherein the one or more stamps are grayscale stamps.

20. The apparatus of claim 11, wherein the deep learning system comprises a system selected from the group consisting of convolutional neural networks (CNN) and Resnet networks.
